(19) United States
(12) Patent Application Publication
(10) Pub. No.: US 2014/0114464 A1
(43) Pub. Date: Apr. 24, 2014

(54) SYSTEM AND METHOD FOR REMOTELY POSITIONING AN END EFFECTOR

(71) Applicants: Christopher Williams, New Castle (GB); Dan Dailey, Cleveland, OH (US); Andrew Oxford, Ladson, SC (US); Yogesh Savalia, Vadodara (IN); Bryan White, Ladson, SC (US)

(72) Inventors: Christopher Williams, New Castle (GB); Dan Dailey, Cleveland, OH (US); Andrew Oxford, Ladson, SC (US); Yogesh Savalia, Vadodara (IN); Bryan White, Ladson, SC (US)

(21) Appl. No.: 14/055,053

(22) Filed: Oct. 16, 2013

Related U.S. Application Data
(60) Provisional application No. 61/717,361, filed on Oct. 23, 2012.

(51) Int. Cl. G05B 19/409

(52) U.S. Cl. CPC G05B 19/409
USPC 700/186

(57) ABSTRACT

A system for remotely positioning an end effector includes an input device and at least one sensor configured to generate at least one signal reflective of a force applied to the input device. A processor receives the at least one signal and is configured to execute logic stored in a memory that causes the processor to compare the at least one signal to a predetermined limit and generate a control signal to the end effector if the at least one signal exceeds the predetermined limit. A method for remotely positioning an end effector includes moving an input device, sensing a force applied to the input device, comparing the force applied to the input device to a predetermined limit, and generating a control signal to the end effector if the force applied to the input device exceeds the predetermined limit.

### PRIORITY CLAIM

The present application claims priority to U.S. Provisional Application Ser. No. 61/717,361, filed Oct. 23, 2012, and which is incorporated herein by reference for all purposes.

### FIELD OF THE INVENTION

The present invention generally involves a system and method for remotely positioning an end effector.

### BACKGROUND OF THE INVENTION

Computer numerically controlled (CNC) machines are known in the art for having a high degree of precision and accuracy. A CNC machine may control, for example, a drill, press, lathe, or other machinery during the manufacture and/or finishing of various parts or components having relatively low manufacturing tolerances. Each CNC machine typically requires some form of initial setup to position an end effector prior to operation. This initial positioning of the end effector is traditionally performed using a bespoke control panel having a combination of switches and/or a rotary dials to precisely control manual positioning of the end effector. For example, an operator may select a first axis to move the end effector and press a switch and/or rotate a potentiometer to move the end effector along the selected first axis at the selected speed. The operator may then repeat the process for two or more axes until the operator has satisfactorily positioned the end effector at the desired position. Although eventually effective at positioning the end effector, this iterative process of selecting a particular axis and moving the end effector along the selected axis can be time consuming and labor intensive.

The development of micro electro-mechanical systems has enabled accelerometers and other sensors to be incorporated into more and more readily available products such as smart phones, tablets, and virtual game controls. As a result, a system and method that uses one or more of these readily available products to remotely position an end effector would be useful to reducing the time and labor associated with positioning the end effector.

### BRIEF DESCRIPTION OF THE INVENTION

Aspects and advantages of the invention are set forth below in the following description, or may be obvious about the description, or may be learned through practice of the invention.

One embodiment of the present invention is a system for remotely positioning an end effector. The system includes an input device and at least one sensor in the input device, wherein the at least one sensor is configured to generate at least one signal reflective of a force applied to the input device. A processor is in communication with the at least one sensor such that the processor receives the at least one signal. The processor is configured to execute a third set of logic stored in a memory that causes the processor to compare the at least one signal to a predetermined limit and generate a control signal to the end effector if the at least one signal exceeds the predetermined limit.

Another embodiment of the present invention is a system for remotely positioning an end effector that includes an input device and a plurality of sensors in the input device, wherein each sensor in the plurality of sensors is aligned with an axis and configured to generate a signal reflective of a force applied to the input device along the axis. A processor is in communication with the plurality of sensors such that the processor receives the signals from the plurality of sensors. The processor is configured to execute a third set of logic stored in a memory that causes the processor to compare the signals from the plurality of sensors to a predetermined limit and generate a control signal to the end effector if the signals from the plurality of sensors exceeds the predetermined limit.

In yet another embodiment, a method for remotely positioning an end effector includes moving an input device, sensing a force applied to the input device, and comparing the force applied to the input device to a predetermined limit. The method generates a control signal to the end effector if the force applied to the input device exceeds the predetermined limit.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is an exemplary block diagram of a system for remotely positioning an end effector according to one embodiment of the present invention;

FIG. 2 is an exemplary input device aligned with first, second, and third axes;

FIG. 3 is an exemplary graph of raw signals reflective of force applied to a sensor along three axes;

FIG. 4 is an exemplary graph of the raw signals shown in FIG. 3 combined into a single signal;

FIG. 5 is an exemplary graph of the combined signal shown in FIG. 4 with an overlay of the same signal filtered and smoothed;

FIG. 6 is an exemplary display of a human machine interface;

FIG. 7 is an exemplary graph of combined, filtered, and smoothed signal shown in FIG. 5 annotated with detected “flicks”; and

FIG. 8 is a block diagram of an algorithm for a method for remotely positioning an end effector according to one embodiment of the present invention.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components. In addition, the terms “upstream” and “downstream” refer to the relative location of components in a pathway. For example, component A is upstream from component B if a signal passes from component A to component B. Conversely, component B is downstream from component A if component B receives a signal from component A.

Each example is provided by way of explanation of the invention, not limitation of the invention. In fact, it will be apparent to those skilled in the art that modifications and variations can be made in the present invention without departing about the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

Various embodiments of the present invention include a system and method for remotely positioning an end effector. The system generally includes a smartphone, tablet, virtual game control, or other portable input device having one or more sensors aligned with orthogonal axes. Each sensor may generate a signal reflective of a force applied to the input device, and a processor in communication with the sensors may receive the signals. The processor may be configured to execute logic stored in a memory to compare the signals to a predetermined limit and to generate a control signal to the end effector if the signals exceeds the predetermined limit. In particular embodiments, the processor may include additional logic that filters the signals, smooth the signals, and/or modifies the processor for different end effectors. Alternately, or in addition, the system may further include an interlock that prevents remote positioning of the end effector unless the interlock is satisfied. Although exemplary embodiments of the present invention will be described in the context of a CNC machine, one of ordinary skill in the art will readily appreciate that embodiments of the present invention may be applied to any end effector, and the present invention is not limited to a CNC machine unless specifically recited in the claims.

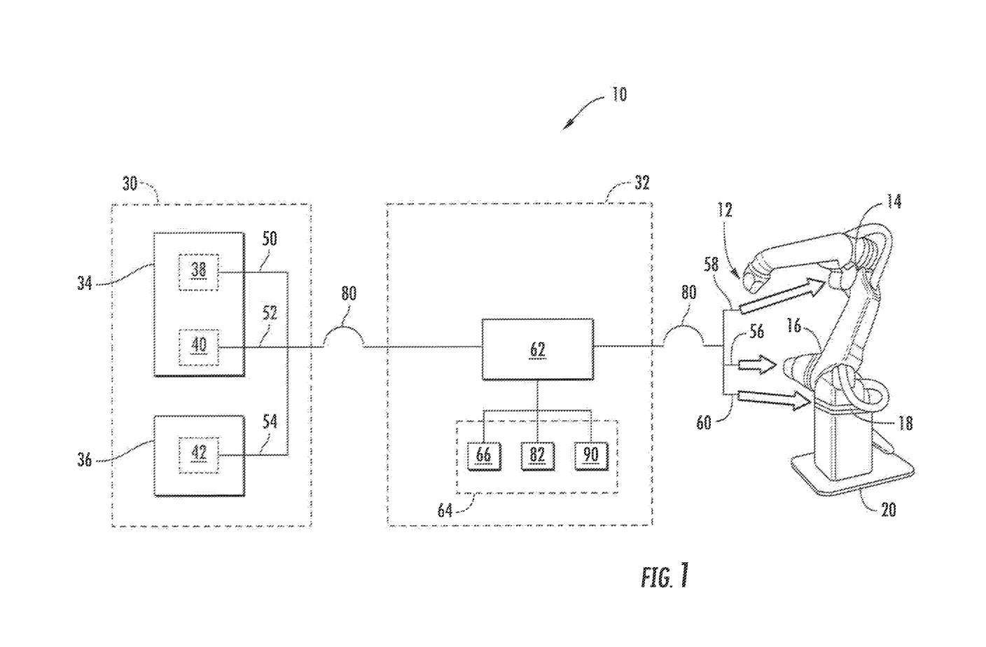

FIG. 1 provides an exemplary block diagram of a system 10 for remotely positioning an end effector 12 according to one embodiment of the present invention. The end effector 12 may include any remotely controlled tool used to cut, grind, machine, finish, or otherwise manufacture a component. For example, the end effector 12 may be a knife, a drill, a router head, a laser, a grinding wheel, or any other manufacturing device known to one of ordinary skill in the art that can be remotely positioned in one or more directions. The end effector 12 may be operably connected to one or more pivots or joints to allow remote positioning of the end effector 12 along a line, in a plane, or in a volume. In the particular embodiment shown in FIG. 1, for example, first, second, and third joints 14, 16, 18 are arranged orthogonal to one another and connect the end effector 12 to a stand 20. Servo-motors or other actuators (not shown) connected to the joints 14, 16, 18 enable movement of the end effector 12 in three dimensions.

As shown in FIG. 1, the system 10 generally includes an input device 30 and a computing device 32 operably connected to the end effector 12. The input device 30 may be, for example, a smartphone, tablet, virtual game controller, or other commercially available portable device having the one or more sensors that can detect and/or quantify movement of the input device 30 along one or more axes. Although various embodiments of the present invention will be described herein as having multiple separate sensors aligned with orthogonal axes for completeness, in particular embodiments the input device 30 may have a single sensor aligned with one or more axes, and the present invention does not require a separate sensor for each axis unless specifically recited in the claims. In addition, although the input device 30 and computing device 32 are illustrated by separate blocks in FIG. 1, one of ordinary skill in the art will readily appreciate that one may be incorporated into the other. For example, the input device 30 may be a smartphone, and the computing device 32 may be an application loaded and operating in the smartphone.

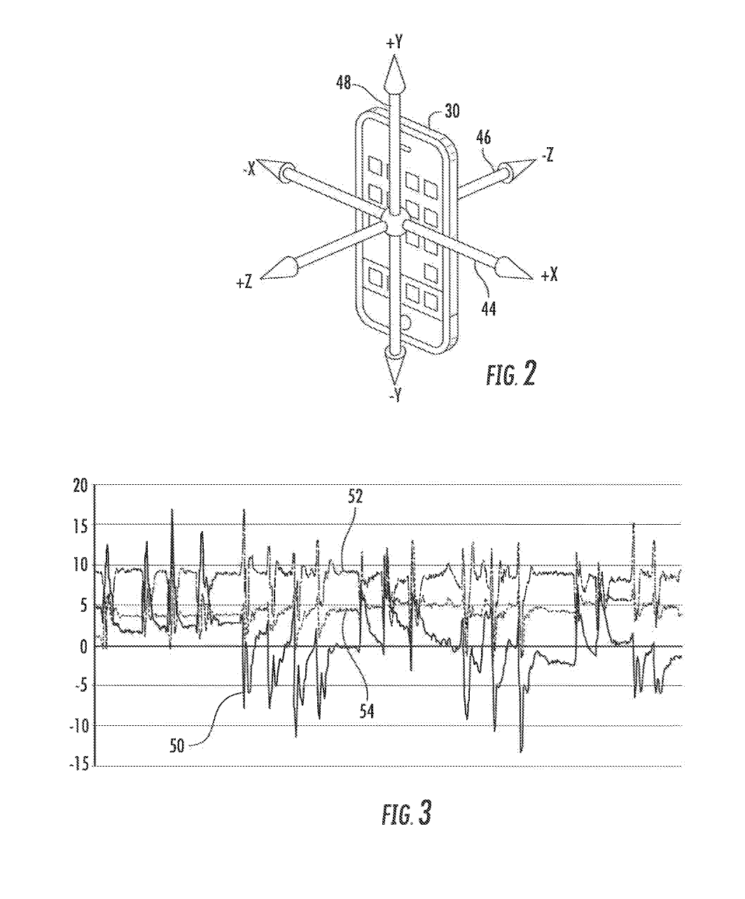

In the particular embodiment shown in FIG. 1, for example, the input device 30 may be a smartphone that includes an accelerometer sensor 34 and an orientation sensor 36. The accelerometer sensor 34 in turn may include a first accelerometer 38 and a second accelerometer 40, and the orientation sensor 36 may include a compass or third accelerometer 42. Each sensor 34, 36 and/or each accelerometer 38, 40, 42 may be aligned with a different orthogonal axis. For example, as shown most clearly in FIG. 2, each sensor 34, 36 and/or each accelerometer 38, 40, 42 (collectively depicted in FIG. 2 as a sphere inside the input device 30) may be aligned with first, second, and third axes 44, 46, 48, respectively. In this manner, each sensor 34, 36 and/or each accelerometer 38, 40, 42 may detect the direction and amount that the input device 30 moves along each respective axis 44, 46, 48.

Returning to the particular embodiment shown in FIG. 1, the first accelerometer 38 may be aligned with the first axis 44 and configured to generate a first signal 50 reflective of a first force applied to the first accelerometer 38 along the first axis 44. Similarly, the second accelerometer 40 may be aligned with the second axis 46 orthogonal to the first axis 44 and configured to generate a second signal 52 reflective of a second force applied to the second accelerometer 40 along the second axis 46. Lastly, the third accelerometer 42 may be aligned with the third axis 48 orthogonal to the first and second axes 44, 46 and configured to generate a third signal 54 reflective of a third force applied to the third accelerometer 42 along the third axis 48. In this manner, the first, second, and third accelerometers 38, 40, 42 may sense motion of the input device 30 in three planes and generate separate signals 50, 52, 54 reflective of the direction and magnitude that the input device 30 has moved along each axis 44, 46, 48. The information contained in these signals 50, 52, 54 may then be processed by the computing device 32 to map the information into a three-dimensional coordinate system to reposition the end effector 12. Specifically, for each sensor 34, 36 or each accelerometer 38, 40, 42, the sign or direction of the force may correspond to the direction of the movement along each respective axis 44, 46, 48 in a single plane, and the magnitude of the force may correspond to the distance of the movement along each respective axis 44, 46, 48 in a single plane. Collectively, the three signals 50, 52, 54 may thus indicate a desired movement of the end effector 12 in a three-dimensional space.

The computing device 32 is in communication with the input device 30 to receive, manipulate, and map the first, second, and third signals 50, 52, 54 into first, second, and third control signals 56, 58, 60 sent to the end effector 12. In general, the computing device 32 may be any suitable processor-based computing device. For example, suitable computing devices may include personal computers, mobile phones (including smart phones), personal digital assistants, tablets, laptops, desktops, workstations, game consoles, servers, other computers and/or any other suitable computing devices. As shown in FIG. 1, the computing device 32 may include one or more processors 62 and associated memory 64. The processor(s) 62 may generally be any suitable processing device(s) known in the art. Similarly, the memory 64 may generally be any suitable computer-readable medium or media, including, but not limited to, RAM, ROM, hard drives, flash drives, or other memory devices. As is generally understood, the memory 64 may be configured to store information accessible by the processor(s) 62, including instructions or logic that can be executed by processor(s) 62. The instructions or logic may be any set of instructions that when executed by the processor(s) 62 cause the processor(s) 62 to provide the desired functionality. For instance, the instructions or logic can be software instructions rendered in a computer-readable form. When software is used, any suitable programming, scripting, or other type of language or combinations of languages may be used to implement the teachings contained herein. Alternatively, the instructions can be implemented by hard-wired logic or other circuitry, including, but not limited to application-specific circuits.

The computing device 32 may also include a network interface for accessing information over a network. The network interface may include, for example, a USB, Wi-Fi, Bluetooth, Ethernet, or Serial interface. The network may include a combination of networks, such as cellular network, WiFi network, LAN, WAN, the Internet, and/or other suitable network and can include any number of wired or wireless communication links. Information may be exchanged through the network interface using secure data packets that is automatically validated to ensure its integrity between devices.

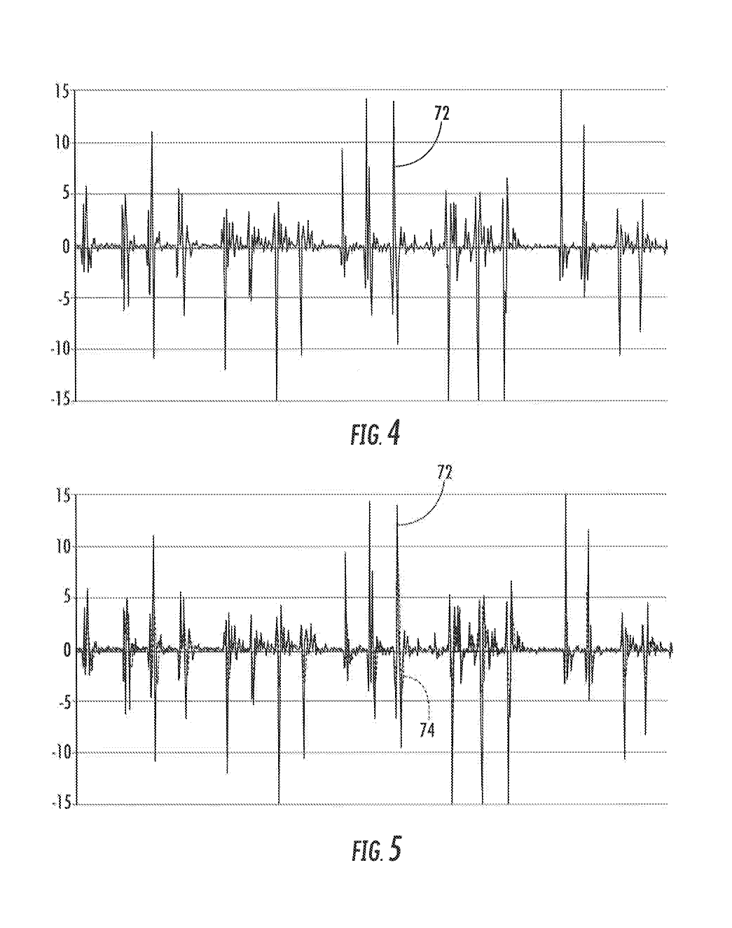

As shown in FIG. 1, the processor 62 is in communication with the first, second, and/or third accelerometers 38, 40, 42 such that the processor 62 receives the first, second, and/or third signals 50, 52, 54. The processor 62 may be configured to execute a first set of logic 66 stored in the memory 64 to combine, filter, and/or smooth the first, second, and/or third signals 50, 52, 54. FIGS. 3-5 provide exemplary graphs of the signals 50, 52, 54 during various stages of manipulation by the processor 62. Specifically, FIG. 3 provides an exemplary graph of the first, second, and third signals 50, 52, 54 generated by the respective first, second, and third accelerometers 38, 40, 42. The first set of logic 66 may enable the processor 62 to vector sum the raw signals 50, 52, 54 to produce a combined signal 72, as shown in FIG. 4. The combined signal 72 thus represents the total force applied to the input device 30 in three dimensions.

As shown in FIGS. 3 and 4, the raw data from the accelerometer and orientation sensors 34, 36 may include substantial noise caused by electromagnetic interference or simply the high sensitivity of the associated first, second, and third accelerometers 38, 40, 42. In addition, different input devices 30 may superimpose varying degrees of noise or jitter signal into the raw signals. If the raw signals 50, 52, 54 shown in FIG. 3 or the combined signal 72 shown in FIG. 4 were not modified, the end effector 12 would be subjected to fast transients, resulting in unnecessary vibrations that would make it difficult to precisely and accurately position the end effector 12. In addition, the unnecessary vibrations would increase the normal wear associated with moving parts and compromise the useful life of the system 10.

The first set of logic 66 may enable the processor 62 to filter and smooth the raw signals 50, 52, 54 shown in FIG. 3 or the combined signal 72 shown in FIG. 4 to remove the fast transients and noisy components within the signal to provide a smoother profile. The first set of logic 66 may include, for example, a transfer function to filter the raw data included in the combined signal 72 to remove the fast transients. The following transfer function is one such model that may be included in the first set of logic 66 for filtering the raw data included in the combined signal 72:

$$H ( jω ) = \frac{1}{\sqrt{1 + {{ɛ}^{2} ( \frac{ω}{ωρ} )}^{2 ο}}} ;$$

where o defines the filter order; ω is equal to 2Πf, where f is the cut off frequency; and ε is the maximum pass band filter gain.

The first set of logic 66 may further include a polynomial splining algorithm to smooth the combined and filtered signal and produce a perturbation free signal. For example, the following general degree n polynomial may be applied to smooth each filtered signal:

P₍ₙ₎(x)=aₙxⁿ+aₙ₋₁xⁿ⁻¹+ . . . +a₁x+a₀

FIG. 5 provides an exemplary graph of the combined signal 72 as shown in FIG. 4 with an overlay 74 of the same signal filtered and smoothed by the processor 62 executing the first set of logic 66. The resulting overlay 74 shown in FIG. 5 thus shows the combined signal 72 after having been filtered by the transfer function to remove the high frequency noise and fast transients and smoothed by the high order polynomial spline to produce an acceptable profile that can be accurately interpreted to create the control signals 56, 58, 60 to move the end effector 12.

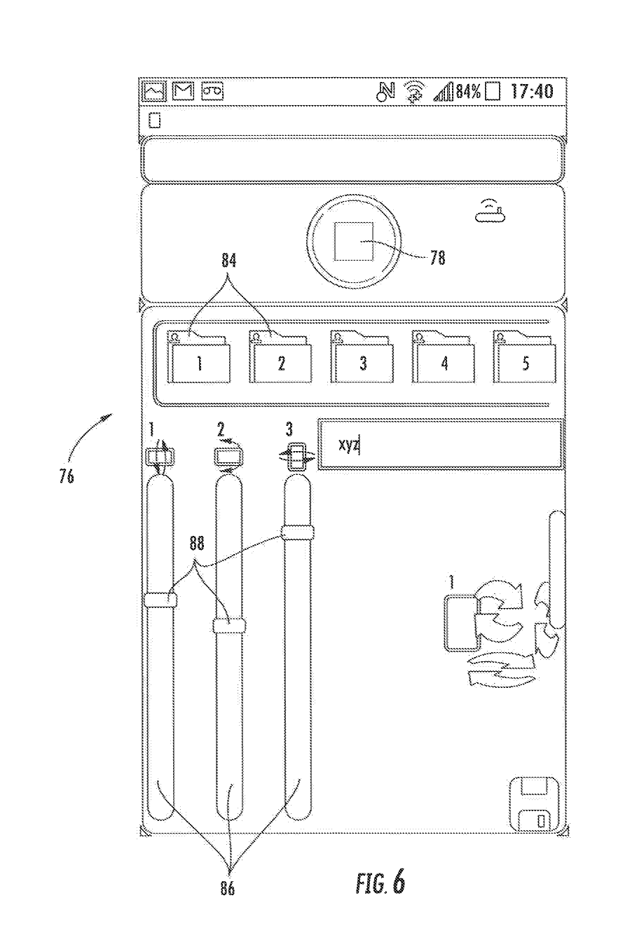

FIG. 6 provides an exemplary display 76 for a human machine interface, also known as a graphic user interface, according to various embodiments of the present invention. The display 76 may be incorporated into the input device 30 and/or the computing device 32 for ready access by a user. As shown in FIG. 6, the user interface may include one or more safety features to protect against accidental end effector 12 movement caused by inadvertent input device 30 movement. For example, the user interface may include an interlock 78 in the form of a hard or soft button that must be depressed or toggled to enable movement of the end effector 12 in one or more directions. In particular embodiments, for example, the interlock 78 may control one or more relay contacts 80 that prevent the first, second, and/or third signals 50, 52, 54 from reaching the computing device 32, as shown in FIG. 1. Alternately or in addition, the relay contacts 80 may prevent the first, second, and/or third control signals 56, 58, 60 from reaching the end effector 12, as additionally shown in FIG. 1. In this manner, the input device 30 may not cause the end effector 12 to move in a particular direction unless the interlock 78 is first satisfied.

Various embodiments of the present invention may also include any combination of hardwired and/or programmable logic to facilitate connecting the system 10 to different end effectors 12. Referring to FIGS. 1 and 6 in combination, for example, the computing system 32 may further include a second set of logic 82 stored in the memory 64 that may be executed by the processor 62 to modify the first set of logic 66 for different end effectors 12. In conjunction with this, the display 76 may include a separate jog profile 84 for each different end effector 12, and selection of a particular jog profile 84 shown on the display 76 may cause the processor 62 to execute the second set of logic 82 to modify the first set of logic 66. In this manner, the same input device 30 may be used for multiple different end effectors 12 having different directions of motion, ranges of motion, sensitivity to motion, acceleration limits or needs, and/or other specific features particular or unique to each end effector 12.

To illustrate this functionality, one particular end effector 12 may be a drill capable of initial positioning in a single plane. Selection of the jog profile 84 associated with the drill may thus cause the second set of logic 82 to modify the first set of logic 66 to null or inhibit any signal that might cause the drill to move outside of the single plane during initial positioning. As another illustration, a particular end effector 12 may be a laser capable of movement in three dimensions, but having different maximum permissible velocities in each dimension. Selection of the jog profile 84 associated with the laser may display a separate velocity scale 86 for each axis on the display 76, as shown in FIG. 6. A sliding control 88 may allow the user to adjust the maximum permissible velocity for each axis, as desired. For particular jog profiles, the adjustment of the maximum permissible velocity for each axis allows the user to adjust the control resolution of velocity for each axis because the full scale velocity may be interpolated between zero and the maximum velocity set by the sliding controls 88. The user interface may communicate the maximum permissible velocity adjustment for each axis to the second set of logic 82, and the second set of logic 82 may in turn cause the processor 62 to modify the first set of logic 66 accordingly. In yet another illustration of the functionality of the second set of logic 82, each jog profile 84 may map a particular sensor 34, 36 and/or accelerometer 38, 40, 42 to a particular axis of movement for the end effector 12. Using the user interface shown in FIG. 6, the user may change the mapping between sensors 34, 36 and axes or between accelerometers 38, 40, 42 and axes, as desired to suit the particular user's preferences, and the second set of logic 82 may effect this change in mapping by modifying the first set of logic 66 accordingly.

Once the raw signals 50, 52, 54 have been combined, filtered, and/or smoothed, as described and illustrated with respect to FIGS. 3-5, and the user has selected the desired jog profile 84, as described and illustrated with respect to FIGS. 1 and 6, the processor 62 may execute a third set of logic 90 stored in the memory 64 that allows the processor 62 to determine if the user intends to move the input device 30, and if so, in what direction and by what distance. In one embodiment, the third set of logic 90 may enable the processor 62 to detect peaks 92 and/or valleys 94 in the filtered and smoothed signals (e.g., raw signals 50, 52, 54 or combined signal 74) and compare the peaks 92 and valleys 94 of the signal(s) to a predetermined limit 96 and to generate one or more control signals 56, 58, 60 to the end effector 12 if the predetermined limit 96 is met or exceeded. The predetermined limit 96 may be an amount of force applied to the input device 30 in either direction along one or more axes 44, 46, 48—i.e., a minimum “flick” 98 of the input device 30—that must be met or exceeded to generate one or more of the control signals 56, 58, 60. If the predetermined limit 96 is met or exceeded by one or more of the signals, the processor 62 may then generate one or more control signals 56, 58, 60 to cause corresponding movement of the end effector 12 in one or more directions. In particular embodiments, a separate predetermined limit 96 may exist for each separate axis, while in other embodiments, the predetermined limit 96 may represent a combined force applied to the input device 30 in two or more combined axes. Similarly, in particular embodiments, the processor 62 may generate a separate control signal for each axis in which the predetermined limit 96 is met, causing the end effector 12 to simultaneously move along multiple axes. In other embodiments, the processor 62 may generate a single control signal that moves the end effector 12 in a single direction. The control signals 56, 58, 60 may move the end effector 12 a discrete and predefined distance for each “flick” 98 detected of the input device 12. Alternately, the control signals 56, 58, 60 may move the end effector 12 a variable distance proportional to the magnitude of the force for each “flick” 98 of the input device 12.

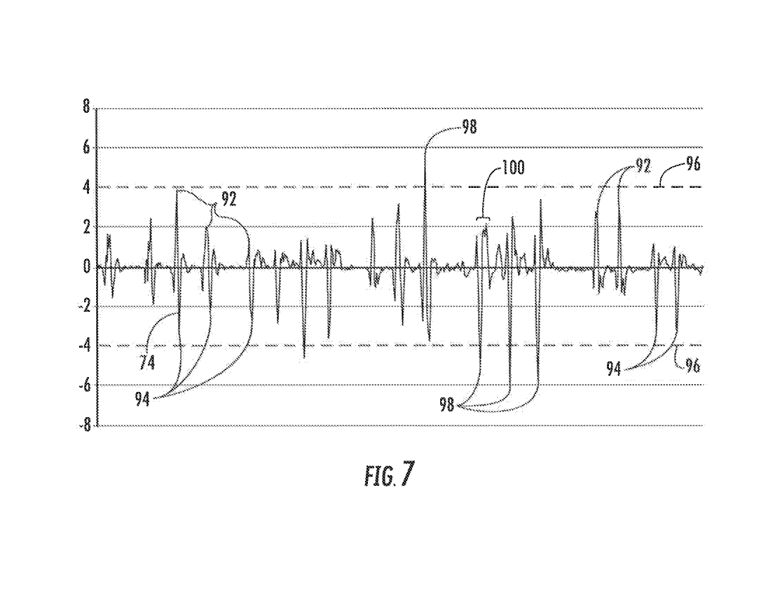

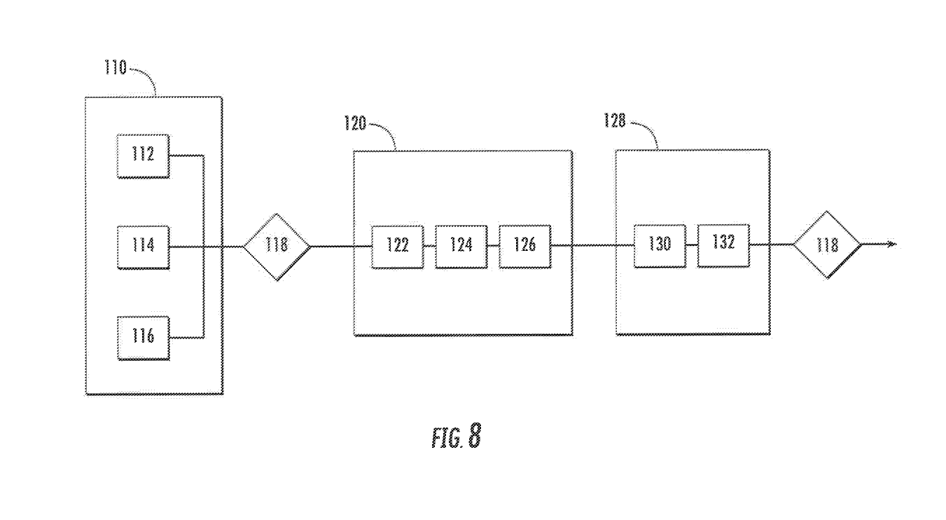

FIG. 7 provides an exemplary graph of the combined, filtered, and smoothed signal shown in FIG. 5 annotated with the peaks 92, valleys 94, and detected “flicks” 98 that exceed the predetermined limit 96. As shown in FIG. 7, the third set of logic 90 may include a programmable time limit 100 that prevents the processor 62 from registering multiple successive peaks 92 and/or valleys 94 in rapid succession that occur within the programmable time limit to reduce inadvertent detection of peaks 92 and/or valleys 94. For each peak 92 and/or valley 94 detected, the processor 62 compares the detected peak 92 and valley 94 to the predetermined limit 96 to determine if the peak 92 and/or valley 94 represents a sufficient flick 98 by the user to generate one or more control signals 56, 58, 60 to the end effector 12. In this manner, the processor 62 may reliably detect and discriminate “flicks” 92 intended by the user to effect movement in the end effector 12 from smaller forces felt by the input device 30.

The embodiments shown and described with respect to FIGS. 1-7 may thus provide a method for remotely positioning the end effector 12, and FIG. 8 provides a block diagram of a suitable algorithm according to one embodiment of the present invention. The method may include moving the input device 30 along one or more axes 44, 46, 48, as shown in FIG. 2 and represented by block 110 in FIG. 8. The method further includes detecting or sensing the force applied to the input device 30 along the one or more axes 44, 46, 48 and generating the signals 50, 52, 54 reflective of the force applied to the sensors 34, 36 and/or accelerometers 38, 40, 42 along the respective axes 44, 46, 48, as represented by blocks 112, 114, and 116. At block 118, the method may include preventing the end effector 12 from moving unless the interlock 78 is satisfied. As previously discussed with respect to FIGS. 1 and 6, this may be accomplished, for example, by interrupting communication of the first, second, and/or third signals 50, 52, 54 to the computing system 32 and/or interrupting communication of the first, second, and/or third control signals 56, 58, 60 to the end effector 12.

Block 120 represents manipulating the raw signals 50, 52, 54. The data manipulation may include, for example, combining 122, filtering 124, and/or smoothing 126 the raw signals 50, 52, 54, as previously discussed with respect to FIGS. 3-5. At block 128, the method maps the one more combined, filtered, and/or smoothed signals 74 to the particular end effector 12 selected by the user. At block 130, for example, the user may select the desired jog profile 84, and at block 132, the processor 62 may compare the combined, filtered, and/or smoothed signal(s) 74 to the predetermined limit 96 and generate the first, second, and/or third control signals 56, 58, 60 to the end effector 12.

One of ordinary skill in the art will readily appreciate multiple possible combinations between the number of sensors 34, 36 and/or accelerometers 38, 40, 42 in the input device 30, the number of resulting signals 50, 52, 54, and the number and variability of control signals 56, 58, 60 are possible within the scope of various embodiments of the present invention. The following examples are provided to illustrate the operation of the system 10 shown in FIG. 1 and/or method shown in FIG. 8.

### Example 1

The input device 30 has a single accelerometer 38 aligned with a single axis 44, and the end effector 12 is capable of movement along more than one axis. As shown in FIG. 6, the user may first select a particular jog profile 84 that can map the force applied to the input device 30 along the single axis 44 to the end effector 12. In addition, the user may select the first axis for initial movement of the end effector 12 and repeat the selection as necessary for subsequent movements of the end effector 12 along the other axes. Lastly, the user may select a discrete or variable amount of movement for the end effector 12 for each “flick” 98 detected by the processor 62. In this particular example, the user selects a discrete distance for the end effector 12 to move for each detected flick 98.

Based on the selected jog profile 84, with the modifications just discussed, as desired, the user may “flick” the input device 30 to command movement of the end effector 12 a discrete distance for each detected “flick” 98 along the first axis 44. The single accelerometer 38 will sense the force applied to the input device 30 along the first axis 44 and generate the first signal 50 reflective of the force applied to the input device 30 along the first axis 44. The processor 62 will then filter and smooth this first signal 50, as shown in FIG. 5, and compare the filtered and smoothed signal 74 to the predetermined limit 96 to determine if the “flick” 98 was large enough to represent an intended movement of the end effector 12 by the user, as shown in FIG. 7. If the force along the first axis 44 exceeds the predetermined limit 96, the processor 62 will generate the first control signal 56 to the end effector 12 to cause the end effector 12 to move the predetermined distance along the first axis 44 in the direction of the force along the first axis 44. The use may then continue to “flick” the input device 30 as desired to effect additional movement in the end effector 12 along the first axis 44. Alternately, the user may return to the jog profile 84 and select a second or third axis 46, 48 for moving the end effector 12, and the process repeats until the end effector 12 is at the desired position.

### Example 2

The input device 30 has first, second, and third accelerometers 38, 40, 42, as shown in FIG. 1, with each accelerometer aligned with a different orthogonal axis 44, 46, 48, as shown in FIG. 2. The end effector 12 is again capable of movement along more than one axis. As shown in FIG. 6, the user may again first select a particular jog profile 84 and first axis 44 for initial movement so the processor 62 can map the force applied to the input device 30 along the first axis 44 to the end effector 12. In addition, the user may select a discrete or variable amount of movement for the end effector 12 for each “flick” 98 detected by the processor 62. In this particular example, the user selects a variable distance proportional to the total force for the end effector 12 to move for each detected flick 98.

Based on the selected jog profile 84, with the modifications just discussed, as desired, the user may “flick” the input device 30 to command movement of the end effector 12. The three accelerometers 38, 40, 42 will sense the force applied to the input device 30 along the respective axes 44, 46, 48 and generate the signals 50, 52, 54 reflective of the force applied to the input device 30 along each axis 44, 46, 48. The processor 62 will then vector sum the signals 50, 52, 54 to generate the combined signal 72, as shown in FIG. 4, and filter and smooth this combined signal 72 to generate the filtered and smoothed combined signal 74, as shown in FIG. 5. The processor 62 may then compare the filtered and smoothed combined signal 74 to the predetermined limit 96 to determine if the “flick” 98 was large enough to represent an intended movement of the end effector 12 by the user, as shown in FIG. 7. If the total force along the three axes 44, 46, 48 exceeds the predetermined limit 96, the processor 62 will generate the first control signal 56 to the end effector 12 to cause the end effector 12 to move in the direction of the force along the first axis 44 and proportional to the total force applied to the input device 12. The user may then continue to “flick” the input device 30 as desired to effect additional movement in the end effector 12 along the first axis 44. Alternately, the user may return to the jog profile 84 and select a second or third axis 46, 48 for moving the end effector 12, and the process repeats until the end effector 12 is at the desired position.

### Example 3

The input device 30 again has first, second, and third accelerometers 38, 40, 42, as shown in FIG. 1, with each accelerometer aligned with a different orthogonal axis 44, 46, 48, as shown in FIG. 2. The end effector 12 is again capable of movement along more than one axis and capable of simultaneous movement along each axis. As shown in FIG. 6, the user may again first select a particular jog profile 84 and associate each axis 44, 46, 48 with a direction of movement so the processor 62 can map the force applied to the input device 30 along each axis 44, 46, 48 to the end effector 12. In addition, the user may select a discrete or variable amount of movement for the end effector 12 for each “flick” 98 detected by the processor 62. In this particular example, the user selects a variable distance proportional to the force along each axis 44, 46, 48 for the end effector 12 to move for each detected flick 98.

Based on the selected jog profile 84, with the modifications just discussed, as desired, the user may “flick” the input device 30 to command movement of the end effector 12. The three accelerometers 38, 40, 42 will sense the force applied to the input device 30 along the respective axes 44, 46, 48 and generate the signals 50, 52, 54 reflective of the force applied to the input device 30 along each axis 44, 46, 48. The processor 62 will then filter and smooth each signal 50, 52, 54 to generate a separate filtered and smoothed signal 74 for each axis, one of which is shown in FIG. 5. The processor 62 will then separately compare the filtered and smoothed signal 74 for each axis 44, 46, 48 to the predetermined limit 96 associated with each axis to determine if the “flick” 98 along one or more of the axes 44, 46, 48 was large enough to represent an intended movement of the end effector 12 by the user, as shown in FIG. 7. The processor 62 will generate a separate control signal 56, 58, 60 for each axis 44, 46, 48 in which the filtered and smoothed signal 74 exceeds the predetermined limit 96, and each control signal 56, 58, 60 will cause the end effector 12 to move in the direction of the force along each axis 44, 46, 48 and proportional to the force applied to the input device 12 along each respective axis 44, 46, 48. The user may then continue to “flick” the input device 30 as desired to effect additional movement in the end effector 12 simultaneously in one or more directions until the end effector 12 is at the desired position.

It is believed that the various embodiments described herein with respect to FIGS. 1-8 may provide one or more advantages over existing technology. For example, the system 10 and method described and illustrated herein may enhance precise initial positioning of the end effector 12 in one or more planes. In addition, the initial positioning may be performed simultaneously in each plane, through intuitive manipulation of a commonly available, off-the-shelf input device 30, and without requiring more time consuming and labor intensive iterative manipulation of multiple buttons and/or wheels for each axis of directed movement. Lastly, in particular embodiments, the system 10 may be easily and conveniently adjusted or tailored for use with different end effectors 12 selected by the user.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ about the literal language of the claims, or if they include equivalent structural elements with insubstantial differences about the literal language of the claims.

What is claimed is:

1. A system for remotely positioning an end effector, comprising:
a. an input device;
b. at least one sensor in the input device, wherein the at least one sensor is configured to generate at least one signal reflective of a force applied to the input device; and
c. a processor in communication with the at least one sensor such that the processor receives the at least one signal, wherein the processor is configured to execute a third set of logic stored in a memory that causes the processor to compare the at least one signal to a predetermined limit and generate a control signal to the end effector if the at least one signal exceeds the predetermined limit.

2. The system as in claim 1, wherein the at least one sensor in the input device comprises a first sensor aligned with the first axis and a second sensor aligned with a second axis orthogonal to the first axis; the first sensor configured to generate a first signal reflective of the force applied to the input device along the first axis; the second sensor configured to generate a second signal reflective of the force applied to the input device along the second axis; and the at least one signal is proportional to a vector sum of the first and second signals.

3. The system as in claim 1, wherein the at least one sensor in the input device comprises a first sensor aligned with the first axis, a second sensor aligned with a second axis orthogonal to the first axis, and a third sensor aligned with a third axis orthogonal to the first and second axes; the first sensor configured to generate a first signal reflective of the force applied to the input device along the first axis; the second sensor configured to generate a second signal reflective of the force applied to the input device along the second axis; the third sensor configured to generate a third signal reflective of the force applied to the input device along the third axis; and the at least one signal is proportional to a vector sum of the first, second, and third signals.

4. The system as in claim 1, wherein the processor is configured to execute a first set of logic stored in the memory that causes the processor to filter the at least one signal reflective of the force applied to the input device.

5. The system as in claim 4, wherein the processor is configured to execute the first set of logic stored in the memory that causes the processor to smooth the at least one signal reflective of the force applied to the input device.

6. The system as in claim 1, further comprising an interlock having a first position that prevents the end effector from responding to the force applied to the input device.

7. The system as in claim 1, wherein the processor is configured to execute a second set of logic stored in the memory to modify the third set of logic for different end effectors.

8. The system as in claim 1, wherein the control signal to the end effector is proportional to the force applied to the input device.

9. The system as in claim 1, wherein the at least one sensor in the input device comprises at least one accelerometer.

10. A system for remotely positioning an end effector, comprising:
a. an input device;
b. a plurality of sensors in the input device, wherein each sensor in the plurality of sensors is aligned with an axis and configured to generate a signal reflective of a force applied to the input device along the axis; and
c. a processor in communication with the plurality of sensors such that the processor receives the signals from the plurality of sensors, wherein the processor is configured to execute a third set of logic stored in a memory that causes the processor to compare the signals from the plurality of sensors to a predetermined limit and generate a control signal to the end effector if the signals from the plurality of sensors exceeds the predetermined limit.

11. The system as in claim 10, wherein the processor is configured to execute a first set of logic stored in the memory that causes the processor to filter the signals from the plurality of sensors.

12. The system as in claim 11, wherein the processor is configured to execute the first set of logic stored in the memory that causes the processor to smooth the signals from the plurality of sensors.

13. The system as in claim 10, further comprising an interlock having a first position that prevents the end effector from responding to the force applied to the input device.

14. The system as in claim 10, wherein the processor is configured to execute a second set of logic stored in the memory to modify the third set of logic for different end effectors.

15. The system as in claim 10, wherein the control signal to the end effector is proportional to the force applied to the input device.

16. The system as in claim 10, wherein the plurality of sensors in the input device comprises at least one accelerometer.

17. A method for remotely positioning an end effector, comprising:
a. moving an input device;
b. sensing a force applied to the input device;
c. comparing the force applied to the input device to a predetermined limit; and
d. generating a control signal to the end effector if the force applied to the input device exceeds the predetermined limit.

18. The method as in claim 17, wherein sensing the force applied to the input device comprises sensing the force applied to the input device along at least two orthogonal axes.

19. The method as in claim 17, further comprising preventing the end effector from moving unless an interlock is satisfied.

20. The method as in claim 17, further comprising mapping the control signal for different end effectors.
